(19) United States
(12) Patent Application Publication
(10) Pub. No.: US 2010/0076944 A1
(43) Pub. Date: Mar. 25, 2010

(54) MULTIPROCESSOR SYSTEMS FOR PROCESSING MULTIMEDIA DATA AND METHODS THEREOF

(75) Inventor: Sachin Purandardas Kamat, Bangalore (IN)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 12/475,032

(22) Filed: May 29, 2009

(30) Foreign Application Priority Data
Sep. 5, 2008 (IN) 2163/CHE/2008

(51) Int. Cl. G06F 7/00; G06F 15/76; G06F 9/06; G06F 12/00

(52) U.S. Cl. 707/705; 712/30; 711/147; 711/E12.002; 712/E09.003; 707/E17.009

(57) ABSTRACT

A method and system for processing multimedia data is provided. The method for processing multimedia data in a multiprocessor system includes enabling communication between a plurality of processors in response to receipt of multimedia data. The method also includes providing portions of the multimedia data selectively to the plurality of processors. Further, the method includes processing the portions of the multimedia data by the plurality of processors. Moreover, the method includes synchronizing the portions of the multimedia data. The method also includes performing at least one of queuing the portions of the multimedia data to be played, playing the portions of the multimedia data and skipping the portions of the multimedia data based on the synchronizing. A system for processing multimedia data includes one or more sub-processors for processing portions of multimedia data selectively. The system also includes a master processor for synchronizing the portions of the multimedia data.

### CROSS-REFERENCE TO RELATED APPLICATION

This U.S. non-provisional patent application claims priority under 35 U.S.C §119 to Indian Patent Application No. 2163/CHE/2008, filed on Sep. 5, 2008, the entirety of which is herein incorporated by reference.

### BACKGROUND

1. Technical Field

The present disclosure relates to the field of multiprocessor systems and more particularly to methods and systems for processing multimedia data using multiprocessor systems.

2. Description of Related Art

Multimedia data including audio and video portions may be coded individually but transmitted together. The coded audio and video portions upon receipt may then be decoded and processed to play the multimedia data. Often, the audio and video portions are decoded and processed by multiple processors in parallel to reduce time. For example, the video portion can be processed by one processor and the audio portion for the corresponding video portion can be processed by another processor.

The multiple processors may be running at different clock speeds, which can lead to time mismatch between the audio and video portions being played (i.e., the audio and video portions may be susceptible to being unsynchronized with one another). Further, the processing can depend on parameters including the type of processor (architecture), the memory size from which the multimedia data is read, the hardware configuration of the system, constrained resources and algorithms used to perform tasks, which can also lead to a time mismatch.

The time mismatch can cause the video to run faster or slower than the audio. The time mismatch can also adversely affect system performance, transmission, etc. On a single processor system this can be achieved through several techniques of lip synchronization. However on multiple processor systems where processing may occur simultaneously across several processors, synchronization of multimedia data may be a challenging task.

### SUMMARY

An example of a method for processing multimedia data in multiprocessor systems includes enabling communication between a plurality of processors in response to receipt of multimedia data. The method also includes providing portions of the multimedia data selectively to the plurality of processors. Further, the method includes processing the portions of the multimedia data by the plurality of processors. Moreover, the method includes synchronizing the portions of the multimedia data. The method also includes performing at least one of queuing the portions of the multimedia data to be played, playing the portions of the multimedia data and skipping the portions of the multimedia data based on the synchronizing.

Another example of a method for processing multimedia data in multiprocessor systems includes enabling communication between a plurality of processors. The method also includes capturing portions of multimedia data selectively to the plurality of processors. Further, the method includes encoding the portions of the multimedia data by the plurality of processors. Moreover, the method includes providing the portions of the multimedia data to a synchronizer. The method also includes synchronizing the portions of the multimedia data by the synchronizer.

An example of a system for processing multimedia data includes one or more sub-processors for processing portions of multimedia data selectively. The system also includes a master processor for synchronizing the portions of the multimedia data.

### BRIEF DESCRIPTION OF THE DRAWINGS

FIG. 1 is a block diagram of a multiprocessor system, in accordance with some embodiments;

FIG. 2 is a block diagram of a master processor, in accordance with some embodiments;

FIG. 3 is a block diagram of a sub-processor, in accordance with some embodiments;

FIG. 4 is a flow chart illustrating methods for processing multimedia data, in accordance with some embodiments;

FIG. 5 is a flow diagram representing an exemplary flow of messages between a master processor and a plurality of sub-processors, in accordance with some embodiments;

FIG. 6 is a flow chart illustrating a method for processing multimedia data, in accordance with some embodiments; and

FIG. 7 is a flow diagram representing an exemplary flow of messages between a master processor and a plurality of sub-processors, in accordance with some embodiments.

### DETAILED DESCRIPTION OF THE EMBODIMENTS

Embodiments of the invention are described more fully hereinafter with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will further be appreciated by one of skill in the art, the present invention may be embodied as methods, systems, and/or computer program products. Accordingly, the present invention may take the form of an entirely hardware embodiment, an entirely software embodiment or an embodiment combining software and hardware aspects. Furthermore, the present invention may take the form of a computer program product comprising a computer-usable storage medium having computer-usable program code embodied in the medium. Any suitable computer readable medium may be utilized including hard disks, CD-ROMs, optical storage devices, or magnetic storage devices.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

The invention is also described using flowchart illustrations and block diagrams. It will be understood that each block (of the flowcharts and block diagrams), and combinations of blocks, can be implemented by computer program instructions. These program instructions may be provided to a processor circuit, such as a microprocessor, microcontroller or other processor, such that the instructions which execute on the processor(s) create means for implementing the functions specified in the block or blocks. The computer program instructions may be executed by the processor(s) to cause a series of operational steps to be performed by the processor(s) to produce a computer implemented process such that the instructions which execute on the processor(s) provide steps for implementing the functions specified in the block or blocks.

Accordingly, the blocks support combinations of means for performing the specified functions, combinations of steps for performing the specified functions and program instruction means for performing the specified functions. It will also be understood that each block, and combinations of blocks, can be implemented by special purpose hardware-based systems which perform the specified functions or steps, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The code may execute entirely on one or more servers, or it may execute partly on a server and partly on a client within a client device or as a proxy server at an intermediate point in a communications network. In the latter scenario, the client device may be connected to a server over a LAN or a WAN (e.g., an intranet), or the connection may be made through the Internet (e.g., via an Internet Service Provider). It is understood that the present invention is not TCP/IP-specific or Internet-specific. The present invention may be embodied using various protocols over various types of computer networks.

It is understood that each block of the illustrations, and combinations of blocks in the illustrations can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block and/or flowchart block or blocks.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

Embodiments of the present disclosure provide a multiprocessor system and a method for processing multimedia data in multiprocessor systems.

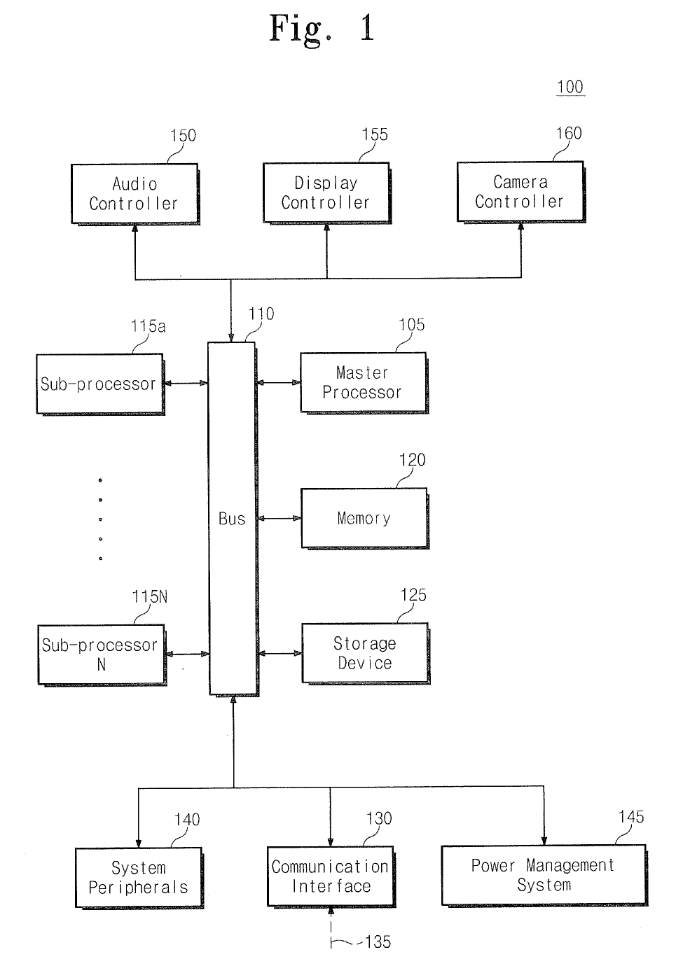

FIG. 1 is a block diagram of a multiprocessor system 100, in accordance with one embodiment. Examples of the multiprocessor system 100 include but are not limited to a computer, a laptop, a personal digital assistant, a mobile or any other multimedia data processing device with a plurality of processors.

The multiprocessor system 100 includes a master processor 105 coupled to a bus 110. One or more sub-processors, for example, a sub-processor 115a and a sub-processor 115N are also coupled to the bus 110 and can interact with each other or with the master processor 105. The multiprocessor system 100 also includes a memory 120, such as random-access memory (RAM) or other dynamic storage device, coupled to the bus 110 for storing information. The memory 120 can be used for storing temporary variables or other intermediate information. A storage device 125, such as a magnetic disk or optical disk, is provided and coupled to bus 110 for storing information.

The multiprocessor system 100 also includes a communication interface 130 coupled to the bus 110 for communicating with a network 135. Examples of the network include, but are not limited to, local area network, wide area network, metropolitan area network, Internet and wireless networks. System peripherals 140 and power management system 145 are also coupled to the bus 110.

The multiprocessor system 100 also includes an audio controller 150, a display controller 155 and a camera controller 160 coupled to the bus 110.

Embodiments of the present disclosure are related to the use of the multiprocessor system 100 for implementing the techniques described herein. In one embodiment, the techniques are performed by the master processor 105 by using information included in the memory 120. Such information can be read into the memory 120 from another machine-readable medium, such as the storage device 125.

The sub-processors and the master processor 105 can be predefined based on the capabilities of the multiprocessor system 100. The master processor 105 and the sub-processors 115 can have different or similar clock speed.

The master processor 105 fetches multimedia data, for example multimedia data, from the storage device 125 or a network stream or the sub-processors. The multimedia data includes audio and video portions. Each portion of the multimedia data includes one or more chunks. Each chunk includes an audio part and a video part. The audio parts of the one or more chunks form the audio portion and the video parts of the one or more chunks form the video portion. The multimedia data can be fetched from the sub-processors if the sub-processors were allotted a task of capturing portions of the multimedia data. The capturing of the portions of the multimedia data can be controlled through the audio controller 150 and the camera controller 160. The master processor 105 enables communication between the one or more sub-processors and the master processor 105 in response to receipt of the multimedia data. The communication can be enabled by the master processor 105 by opening an inter processor communication channel. The inter processor communication channel is used for sending and receiving messages between the one or more sub-processors and the master processor 105. The memory 120 can act as a shared memory and can be accessed by the master processor 105 and the one or more sub-processors. The multimedia data is loaded into the main memory 120 from storage device 125 if it is stored in the form of a file or it is downloaded directly to the main memory if it is read from a network stream. The master processor sends pointers, the pointers are address of memory location to portions of multimedia data stored in the shared memory 120 to the one or more sub-processors. For example, a pointer to a portion of multimedia data that needs to be processed by the sub-processor 110a is sent to the sub-processor 110a. The sub-processors then process the portions of the multimedia allotted to them. The sub-processors send the respective portions of the multimedia data to the master processor 105. The master processor 105 synchronizes the portions of multimedia data.

In some embodiments, the multiprocessor system 100 can include the master processor 105 and one sub-processor only. The master processor can then also function as a sub-processor.

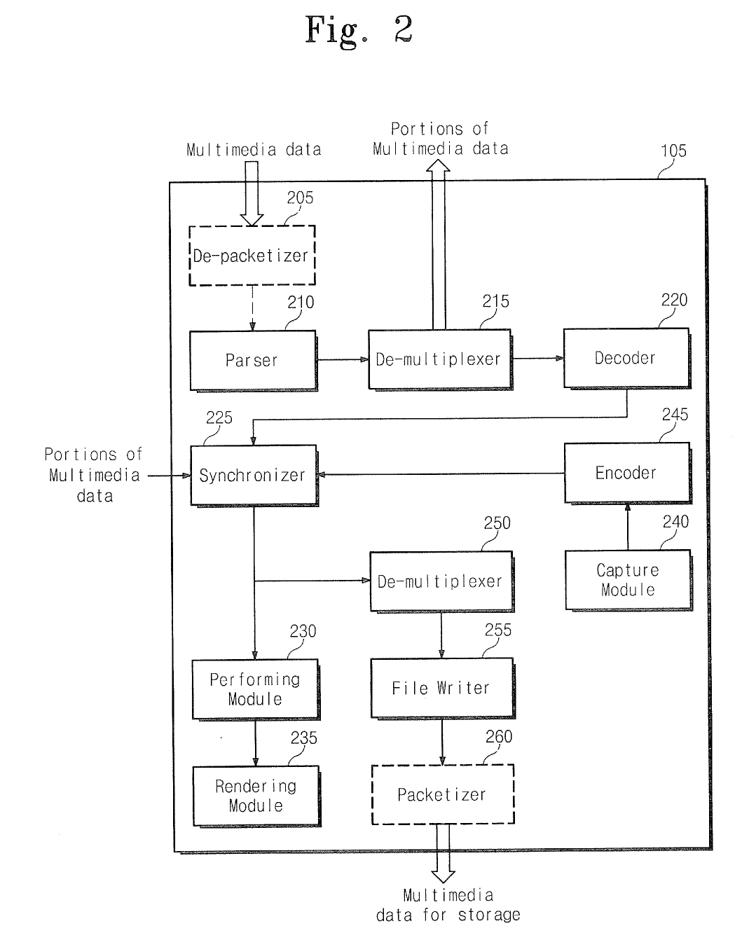

The master processor 105 can do various pre-processing and post-processing activities before and after synchronizing the portions of the multimedia data. The master processor 105 can include various modules for performing the pre-processing activities, post-processing activities and various other functions. The master processor 105 including various modules is explained in details in conjunction with FIG. 2.

FIG. 2 is a block diagram of a master processor 105, in accordance with one embodiment.

The master processor 105 fetches multimedia data from a file stored in a storage device or a network stream. The multimedia data is parsed by a parser 210 and de-multiplexed by a de-multiplexer 215 into one or more portions. Each portion of the multimedia data includes one or more chunks. Each chunk includes an audio part and a video part. The audio parts of the one or more chunks form the audio portion and the video parts of the one or more chunks form the video portion. The portions of the multimedia are then sent to one or more sub-processors for decoding. The portions can be provided by using a shared memory or can be sent as streams.

In one embodiment, the multimedia data may be fetched from a network stream. The multimedia data is de-packetized first by the de-packetizer 205 before parsing and de-multiplexing.

In some embodiments, the master processor acts as a sub-processor and includes a decoder 220 for decoding a portion of the multimedia data. The multimedia data upon decoding is stored in the shared memory or local memory of individual sub-processor.

A synchronizer 225 receives decoded information from the sub-processors and the decoder 220. The synchronizer 225 checks if the multimedia data upon decoding is ahead of time, in time or delayed. A decision is made by the synchronizer 225 and is conveyed through messages to a performing module 230. The synchronizer 225 can also include a lip syncing module for performing lip syncing. The performing module 230 uses the multimedia data from the shared memory and performs at least one of queuing the portions of the multimedia data to be played, playing the portions of the multimedia data and skipping the portions of the multimedia data based on the synchronizing. The performing module 230 performs playing the portions of the multimedia data through rendering module 235.

In one embodiment, the decision made by the synchronizer 225 is conveyed to the performing module of the sub processor.

It will be appreciated that any stream de-packetizer, multimedia parser and de-multiplexer can be used based on the format of the multimedia data fetched.

In another embodiment, a capture module 240 captures a portion of multimedia data and sends the portion to an encoder 245 for encoding. The synchronizer 225 receives the portions of the multimedia data from the sub-processors and the encoder 245. The synchronizer 225 synchronizes the portions of multimedia data and sends the portions of the multimedia data to a multiplexer 250 and file writer 255 for writing the multimedia data into files. The multiplexed file including the multimedia data can then be stored in the storage device.

In one embodiment, if the multimedia data is to be streamed over the network, the multiplexed file including the multimedia data is packetized by a packetizer 260 and streamed over a network.

It will be appreciated that any file writer, packetizer and multiplexer can be used based on the format of the multimedia data fetched. The master processor 105 can also include a memory for storing information.

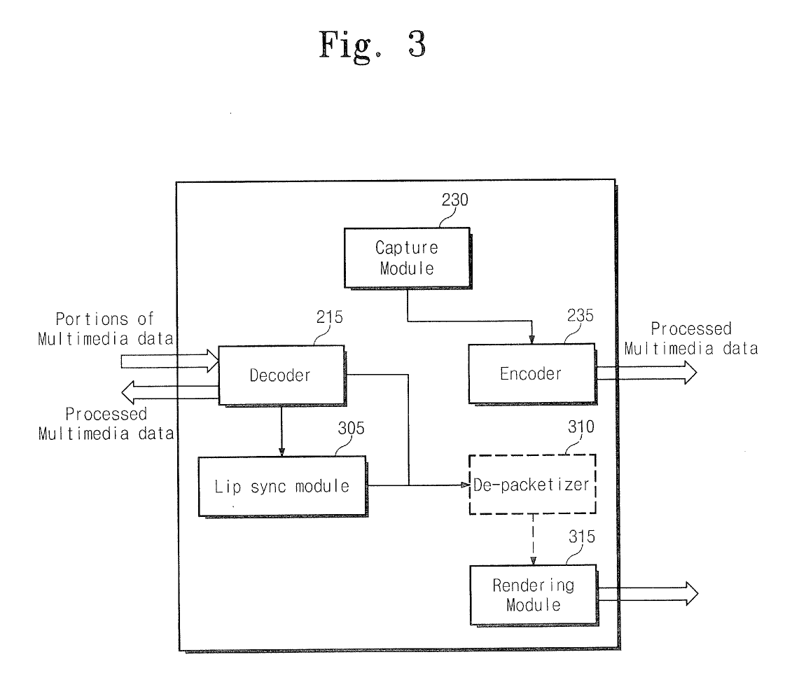

FIG. 3 is a block diagram of a sub-processor 115a, in accordance with one embodiment. The sub-processor 115a receives a portion of multimedia data from a master processor. The sub-processor 115a can receive a pointer to the portion in a shared memory or can receive the portion as a stream. A decoder 215 decodes the portion of multimedia data and sends the decoded portion of the multimedia data to the master processor.

In some embodiments, the sub-processor 115a can include a lip sync module 305 for lip syncing. The lip syncing module 305 can be in communication with lip syncing modules of other sub-processors for sharing information. The portion of multimedia data can then be provided to a rendering module 315 which plays or skips the portion of multimedia data based on the instructions from the master processor or a synchronizer of the master processor. The sub-processor 115a can also include a memory for storing information.

In one embodiment, the instruction from the master processor or the synchronizer of the master processor is sent to a performing module 310 of the sub processor 115a. The performing module 310 has access to the rendering module 315 which plays or skips the portion of multimedia data.

In another embodiment, a capture module 230 captures a portion of multimedia data and sends the portion to an encoder 235 for encoding. The multimedia data is then provided to the master processor.

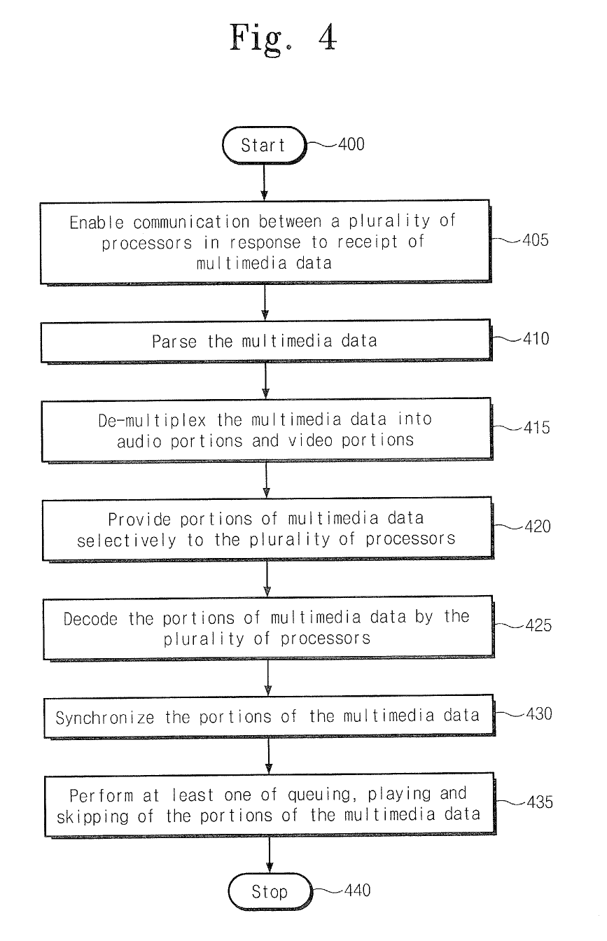

FIG. 4 is a flow chart illustrating a method for processing, for example decoding, multimedia data, in accordance with one embodiment.

The method starts at step 400.

Multimedia data is received by a master processor of a multiprocessor system. The multiprocessor system includes one or more sub-processors. The master processor can also act as a sub-processor in case there is only one sub-processor or in other cases when needed.

At step 405, a communication is established between a plurality of processors, for example, the master processor and the one or more sub-processors in response to the receipt of multimedia data. The multimedia data can be fetched from a file stored in a storage device or from a network stream.

In some embodiments, while the multimedia data is being read from the file or the stream the master processor sends an initialization request, INIT, to the sub-processors. The reading of multimedia data includes performing steps 410 and 415. After the initialization is complete the sub-processors indicate the completion to the master processor by sending a READY signal.

At step 410, the multimedia data is parsed.

At step 415, the multimedia data is de-multiplexed into audio and video portions. One portion includes one or more frames and each frame includes either an audio part or a video part. The audio parts of the one or more flames form the audio portion and the video parts of the one or more frames form the video portion.

At step 420, the audio and video portions of multimedia data are selectively provided to the sub-processors. The master processor can select a sub-processor to process the audio portion and another sub-processor to process the corresponding video portion of the multimedia data. Several such portions can be sent to the sub-processors one after the other for processing. In some embodiments, the master processor can send the audio portion to the sub-processor and can process the video portion itself.

The audio portion and the video portion can be provided to the sub-processors either as a stream or can be shared through a shared memory. A pointer to the shared portion for processing can then be sent to the sub-processors in RECEIVE signal.

At step 425, the sub-processors decode the portions of multimedia data. The sub-processors indicate the completion of decoding to the master processor by sending customized messages. In some embodiments, the master processor can decode a portion itself. The audio portion and the video portion can be sent to the master processor either as a stream or can be shared through a shared memory.

At step 430, the portions of multimedia data are synchronized. The synchronization includes checking if a portion is available ahead of time, in time or delayed.

At step 435, at least one of queuing the portions of the multimedia data to be played, playing the portions of the multimedia data, and skipping the portions of the multimedia data is performed based on the synchronizing. For example, if the portion is available ahead of time then the portion is queued and played at appropriate time, if the portion is in time then the portion is rendered and played, and if the portion is delayed then the portion is skipped. The master processor takes the decision and communicates the decision to the sub-processors for queuing, playing or skipping the portions. In some embodiments, the master processor can perform queuing, playing or skipping.

Steps 405 to 435 can be repeated until the entire multimedia data is decoded.

The method stops at step 440.

The method as described in FIG. 4 is explained in conjunction with following example:

Consider a dual core processor system. The audio portion corresponding to two frames are processed on a sub-processor and video portion corresponding to the same two frames are processed on a master processor. Once, audio portions are decoded, the sub-processor sends a message to the master processor. The synchronization module in the master processor checks the display time of video portion and render time of audio portion. If the video portion is ahead of time as compared to the audio portion then the video portion is queued, if the video portion is in time then the video portion is played with the audio portion, and if the video portion is delayed then the video portion is skipped and the audio portion continues to play.

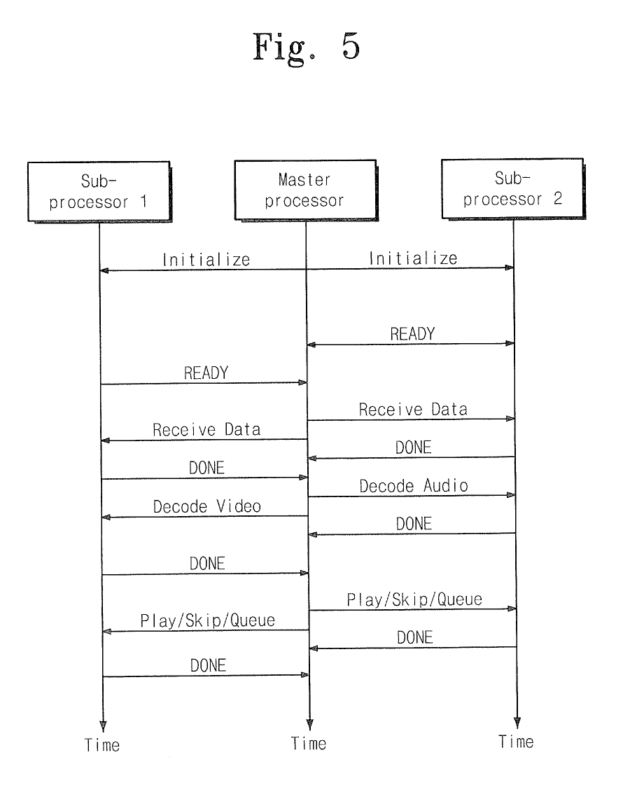

FIG. 5 is a flow diagram representing an exemplary flow of messages between master processor and a plurality of sub-processors, in accordance with one embodiment.

While the multimedia data is being read from an input file or stream, the master processor sends the initialization request, INIT, to the sub-processors in the form of a message. Once the streams are parsed, the master processor waits for the READY signal from the sub-processors. The ready state indicates the readiness of the sub-processor to receive multimedia data from the master processor.

The master processor reads the multimedia data from the streams into a memory. The multimedia data is shared with the sub-processors by any means of inter-processor communication, for example through a shared memory. The master processor sends the information of data shared to the respective sub-processors. The RECEIVE DATA message consists of the pointer, the pointer contains an address of memory location of where data resides to the multimedia data in the shared memory. The sub-processors upon reading the multimedia data send customized messages to the master processor acknowledging the receipt, for example DONE.

The sub-processors then decode the portions allotted by the master processor. For example, sub-processor 1 receives DECODE VIDEO signal and decodes video portion and sub-processor 2 receives DECODE AUDIO signal and decodes audio portion. The sub-processors send DONE to the master processor. The master processor then synchronizes the portions and takes further decision based on the synchronization. The master processor sends QUEUE, PLAY or SKIP message to the sub processors. The sub-processors then send DONE message.

The messages that can be exchanged between the master processor and the sub-processor can include:
Stream type (video or audio)
Stream number (in case of more than one audio and video stream)
Packet number (for a given stream)
Message (could be string or a code)
Data pointer (in case of reference to shared memory)
Other data (if any)

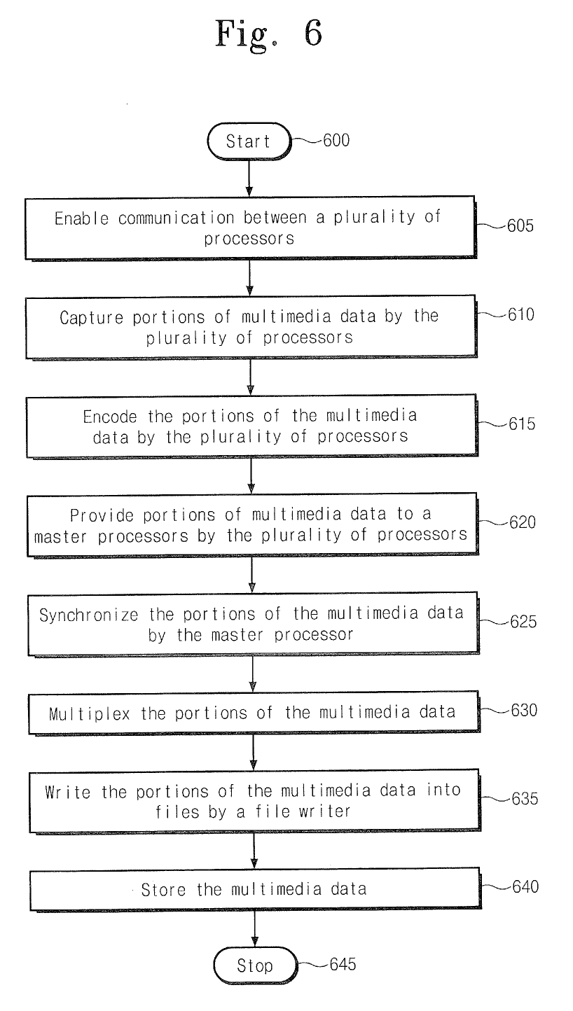

FIG. 6 is a flow chart illustrating a method for processing, for example encoding, multimedia data, in accordance with another embodiment.

The method starts at step 600.

A multiprocessor system includes a plurality of processors including one or more sub-processors and a master processor. The master processor can also act as a sub-processor in case there is only one sub-processor or in other cases when needed.

At step 605, a communication is established between a plurality of processors, for example, the master processor and the one or more sub-processors.

At step 610, the plurality of sub-processors captures portions of multimedia data. For example, one sub-processor can capture audio portion and another sub-processor can capture video portion for the same frames. In another example, one sub-processor can capture audio portion and the master processor can capture video portion for the same frames.

At step 615, the portions of multimedia data are encoded by the plurality of processors. For example, encoder of one sub-processor can encode audio portion and encoder of another sub-processor can encode video portion. In another example, encoder of one sub-processor can encode audio portion and encoder of the master processor can encode video portion.

At step 620, the portions of the multimedia data are provided to the master processor by the plurality of processors. For example, one sub-processor provides audio portion and another sub-processor provides video portion. In another example, one sub-processor can provide audio portion and encoder of the master processor can provide video portion. The audio portion and the video portion can be sent to the master processor either as a stream or can be shared through a shared memory. A pointer to the shared portion can be sent.

At step 625, the portions of the multimedia data are synchronized by a synchronizer of the master processor.

At step 630, the portions of the multimedia data are multiplexed.

At step 635, the portions of the multimedia data are written into files by a file writer.

At step 640, the portions of the multimedia data are stored in a storage device.

Steps 605 to 640 can be repeated until the entire multimedia data is encoded.

The method stops at step 645.

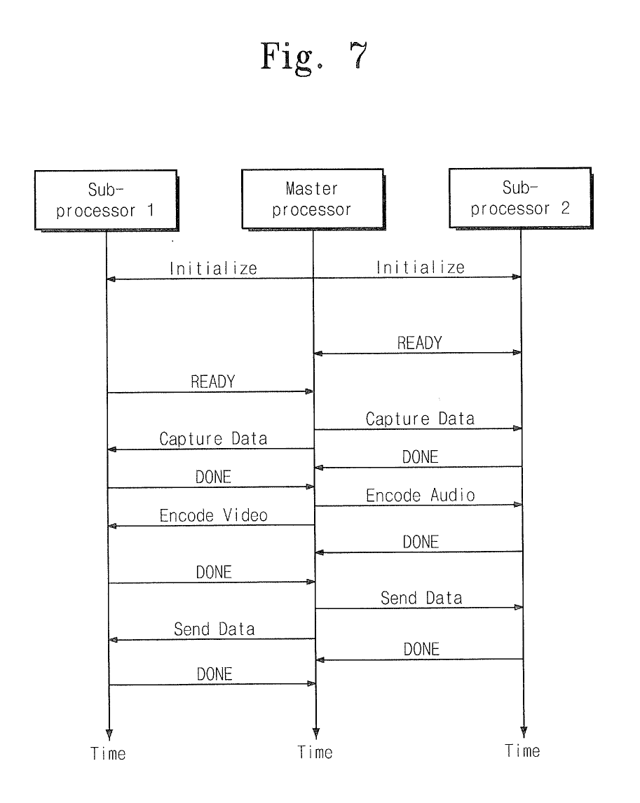

FIG. 7 is a flow diagram representing an exemplary flow of messages between master processor and a plurality of sub-processors, in accordance with another embodiment.

The master processor sends INIT message to the sub-processors. The sub-processors after performing all the initialization routines send the DONE message to the master processor. The master processor issues the CAPTURE message to the respective sub-processors. The sub-processors acknowledges by sending DONE. The master processor sends the ENCODE message to the sub-processors. For example, the master processor sends ENCODE VIDEO message to sub-processor 1 and sends ENCODE AUDIO message to sub-processor 2 for the similar one or more frames. The sub-processors after completing the encode operation sends DONE message back to the master processor. The master processor sends the SEND DATA message to the sub-processors. The sub-processors transfer the data to the master processor through any known means of data sharing in multiprocessor systems. The sub-processors send the data pointer in case of shared memory system and if the data is too small, the sub-processors send the portion of the multimedia data as part of the message itself. The master processor then does other post processing work on the received multimedia data.

Various embodiments of the present disclosure optimize time mismatch by using a synchronizer for synchronizing the portions of multimedia data received from processors running at similar or different clock frequency. Further, the audio and video portions are managed and synchronized efficiently through customized messages.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

What is claimed is:

1. A method for processing multimedia data in a multiprocessor system, the method comprising:
enabling communication between a plurality of processors in response to receipt of multimedia data;
providing portions of the multimedia data selectively to the plurality of processors;
processing the portions of the multimedia data by the plurality of processors;
synchronizing the portions of the multimedia data; and
performing at least one of:
queuing the portions of the multimedia data to be played;
playing the portions of the multimedia data; and
skipping the portions of the multimedia data based on the synchronizing.

2. The method of claim 1, wherein the plurality of processors comprises:
a master processor; and
one or more sub-processors.

3. The method of claim 1 further comprising:
parsing the multimedia data; and
de-multiplexing the multimedia data into audio portions and video portions.

4. The method of claim 1, wherein providing comprising:
sending the audio portions and the video portions to different sub-processors.

5. The method of claim 4, wherein the providing further comprises:
sharing the portions of the multimedia data through a shared memory.

6. The method of claim 5, wherein the providing further comprises:
sending a pointer to the portions of the multimedia data in the shared memory.

7. The method of claim 1, wherein each portion of the multimedia data comprises:
one or more frames of the multimedia data.

8. The method of claim 1, wherein the processing comprises:
decoding the portions of the multimedia data by the plurality of processors.

9. The method of claim 1, wherein the synchronizing comprises:
checking at least one of the portions of the multimedia data are available ahead of time, the portions of the multimedia data area available in time and the portions of the multimedia data are delayed.

10. A method for processing multimedia data in a multiprocessor system, the method comprising:
enabling communication between a plurality of processors;
capturing portions of multimedia data selectively by the plurality of processors;
encoding the portions of the multimedia data captured by the plurality of processors;
providing the portions of the multimedia data to a synchronizer; and
synchronizing the portions of the multimedia data by the synchronizer.

11. The method of claim 10, wherein the plurality of processors comprises:
a master processor; and
one or more sub-processors.

12. The method of claim 10, wherein the providing comprises:
sharing the multimedia data through a shared memory.

13. The method of claim 12, wherein the providing further comprises:
sending a pointer to the multimedia data in the shared memory.

14. The method of claim 10 further comprising:
multiplexing the portions of the multimedia data
writing the portions of the multimedia data into files; and
storing the multimedia data.

15. A system for processing multimedia data, the system comprising:
a master processor for synchronizing the portions of the multimedia data, wherein the master processor further comprises:
a synchronizer for synchronizing the portions of the multimedia data;
a performing module for performing at least one of:
queuing the portions of the multimedia data to be played;
playing the portions of the multimedia data; and
skipping the portions of the multimedia data based on the synchronizing; and
an inter processor communication channel connecting a plurality of sub processors for processing portions of multimedia data selectively.

16. The system of claim 15, wherein the master processor further comprises:
a parser for parsing the multimedia data; and
a de-multiplexer for de-multiplexing the multimedia data.

17. The system of claim 15, wherein the master processor further comprises:
a decoder for decoding a portion of the multimedia data.

18. The system of claim 15, wherein the master processor further comprises:
a multiplexer for multiplexing the portions of the multimedia data;
a file writer for writing the multimedia data into files in memory.

19. The system of claim 15, wherein the master processor further comprises:
a capture module for capturing a portion of multimedia data; and
an encoder for encoding the portion of the multimedia data.

20. The system of claim 15, wherein each of the plurality of sub-processors comprises:
a capture module for capturing a portion of multimedia data; and
an encoder for encoding the portion of the multimedia data.

21. The system of claim 15, wherein each sub-processor comprises:
a decoder for decoding a portion of the multimedia data.

22. A method for processing multimedia data in a multiprocessor system including a master processor and at least one sub-processor in communication with the master processor, the method comprising:
transmitting a queue decoded video command from the master processor to the at least one sub processor responsive to the master processor determining that decoded video portions of the multimedia data having associated synchronized time that is after current decoded audio portions to be played;
transmitting a play decoded video command from the master processor to the at least one sub processor responsive to the master processor determining that decoded video portions of the multimedia data having associated synchronized time that is about concurrent with current decoded audio portions to be played; and
transmitting a skip decoded video command from the master processor to the at least one sub processor responsive to the master processor determining that decoded video portions of the multimedia data having associated synchronized time that is before current decoded audio portions to be played.
